(19) United States
(12) Patent Application Publication
(10) Pub. No.: US 2011/0094397 A1
(43) Pub. Date: Apr. 28, 2011

(54) HEATING-TYPE MULTICOLOR PRINTING METHOD USING ROTARY MULTICOLOR SCREEN PRINTER

(75) Inventors: Yosuke Kitagawa, Kyoto (JP); Osamu Sasaki, Kyoto (JP); Hirofumi Shimokawa, Kyoto (JP)

(73) Assignee: MATSUI SHIKISO CHEMICAL CO., LTD., KYOTO (JP)

(21) Appl. No.: 12/937,594

(22) PCT Filed: Apr. 13, 2009
(86) PCT No.: PCT/JP2009/001690

§ 371 Date: Jan. 5, 2011

(30) Foreign Application Priority Data
Apr. 14, 2008 (JP) 2008104412

(51) Int. Cl. B41F 15/04; B41M 1/12

(52) U.S. Cl. 101/115; 101/129

(57) ABSTRACT

Disclosed are heating-type multicolor printing methods (i), (ii), and (iii). The heating-type multicolor printing method (i) uses a rotary multicolor screen printer and is characterized in that (1) an aqueous printing binder containing a thickening inhibiting component is used and (2) continuous printing is performed while keeping the temperature of the table (pallet) of the printer at 60 to 100° C. The heating-type multicolor printing method (ii) is characterized in that, in the method (i), the aqueous printing binder contains 10 to 60% of a hydrophilic solvent having a boiling point above the boiling point of water as a thickening inhibiting component. The heating-type multicolor printing method (iii) is characterized in that, in the method (i) or (ii), the aqueous printing binder further contains 2 to 10% of urea as the thickening inhibiting component.

### TECHNICAL FIELD

The present invention relates to a heating-type multicolor printing method using a rotary multicolor screen printing machine.

### BACKGROUND ART

As a method for printing characters and patterns onto textile and clothing, pigment printing methods are used. In a pigment printing method, a printing ink consisting of a pigment dispersion and a binder resin is printed onto a textile or clothing, then dried under room temperature or dried by heating, and cured by heating, so that the ink is fixed onto the textile or clothing.

Printing methods include “silk screen printing” wherein the design of a screen mesh of 50-180 meshes/inch spread on a frame is continuously printed, and “rotary screen printing” wherein the design of a cylindrical metal screen mesh of 50-150 meshes/inch is continuously printed. Screen printing machines relating to these printing methods include long-platform-type hand screen printing machines for printing long materials, automatic screen printing machines of traveling-type or belt-conveyer-type, and rotary screen printing machines, etc.

Meanwhile, printing machines for printing cut fabric and sewn products such as T shirts, etc. include the following: T-shirt printing tables wherein fabric is placed on a printing table and printed by a hand screen; rotary (turn-table type) multicolor screen printing machines wherein stages consisting of a screen stencil (in which a screen mesh is extended on a frame) and a hot air dryer are arranged radially on the circumference of the turn table, and wherein pallets (printing tables) are rotated and circled around the turn table in an intermittent manner to enable multicolor screen printing; elliptical multi-station-type screen printing machines wherein stages consisting of a screen stencil (in which a screen mesh is extended on a frame), a hot air dryer, and a cooling device are arranged in an elliptical shape, and wherein pallets (printing tables) are rotated and circled around the turn table to enable multicolor screen printing.

With the above rotary multicolor screen printing machines, printing (screen printing) on T shirts or cut fabric is possible by using plastisol inks consisting of vinyl chloride and a plasticizer.

Said plastisol inks are semi-gelled by only 6-10 s of exposure to a hot air dryer after being printed (screen printed) on a fabric, and no finger-tack is generated on the ink surface, and no finger-tack is present even under heated condition; therefore, even when the ink is pressed by a screen stencil due to squeezing of the next ink in the next printing process, blocking of the ink on the back of the stencil does not occur, so that continuous printing (screen printing) by the next ink is possible.

When such a plastisol ink is printed (screen printed) on a colored fabric, it is possible to print (screen print) the entire pattern, as a hiding layer, with a white plastisol ink to form a white hiding layer, and the layer is irradiation-dried by a hot air dryer, then plural color inks are printed (screen printed) on it as colored layers.

As described above, the use of plastisol inks consisting of vinyl chloride and a plasticizer enables continuous printing using a rotary multicolor screen printing machine; the reason for this is attributed as follows: a plastisol ink consisting of vinyl chloride and a plasticizer has a characteristic of being semi-gelled by heating for a short period of time, because vinyl chloride is swollen by the plasticizer due to heating; it also has a characteristic of having no tackiness on its semi-gelled surface.

Namely, when the above plastisol inks are printed using a rotary multicolor screen printing machine, each table (pallet) of the printing machine is heated by a hot air dryer for 6-10 s as well as its residual heat, and the plastisol inks are made into a semi-gelled state due to this heat, enabling continuous multicolor printing.

Furthermore, the plastisol inks consisting of vinyl chloride and a plasticizer do not dry under room temperature, but they dry (they are semi-gelled) through heating by a hot air dryer; thus no clogging occurs during continuous printing, and therefore the plastisol inks are suitable for rotary multicolor screen printing machines.

Moreover, after printing, the plastisol ink finally becomes completely gelled by being passed through a tunnel dryer at 130-160° C., providing (color) fastness to the fabric.

However, since the above plastisol inks consist of vinyl chloride and a plasticizer, their use is limited due to the toxicity and environmental problems.

In addition, while such plastisol inks have a characteristic of being semi-gelled by heat, and such a characteristic is advantageous in terms of continuous printing using the above printing machines, on the negative side, the heat of the tables (pallets) heated by the hot air dryer is conducted to the screen stencil, leading to making the plastisol inks during printing semi gelled to increase their viscosity. Accordingly, it was impossible to increase the production yield by excessively increasing the temperature of the hot air dryer or by increasing the irradiation time.

Moreover, there are disadvantages in terms of quality of the printed fabric, such as heavy inks, no breathability, hard texture, poor stretching properties, and crack occurrence after washing.

Therefore, as a corrective measure for various problems regarding printed materials using the above plastisol inks, printing using a water-based printing binder is considered.

However, in printing using a water-based printing binder, water content evaporates during continuous printing, leading to thickening of the ink and occurrence of clogging of the screen stencil; accordingly, printing by a fine screen mesh was difficult and printing fine and thin patterns was impossible.

Furthermore, after printing the first color, finger-tack is present in a still-heating condition when drying is carried out by a hot air dryer, so that blocking of the ink on the back of the stencil occurs upon squeezing of the next screen stencil.

Moreover, in the case of inks wherein stretching properties are required, because the amount of a synthetic resin emulsion blended is large, such disadvantages are enhanced; thus, it was impossible to continuously print water-based printing binders using a rotary multicolor screen printing machine.

Accordingly, in printing (screen printing) with conventional water-based printing binders, printing is actually carried out by a printing (screen printing) operator who takes care of clogging and thickening of the ink, using hand screen printing by means of a long screen platform or using an automatic elliptical multi-station screen printing machine wherein more than 30 stages are equipped.

However, the hand screen printing as described above is an extremely inefficient printing method because in the multicolor printing, a drying step by a dryer or fan is carried out after each step of color printing, then the next ink is printed ( ) in addition, since all steps are carried out manually, a constant level of quality cannot be maintained.

Meanwhile, in the case of automatic elliptical multi-station screen printing machines wherein more than 30 multiple stages are arranged, multicolor printing (screen printing) is carried out as follows: after printing (screen printing) the first color, 2 stages of exposure by a hot air dryer is performed, then 2 stages of cooling is carried out to prevent blocking on the back of the stencil by squeezing the next ink, then printing (screen printing) of the next ink is performed.

However, such a printing method requires a large number of stages. For example, in the case of 5-color printing, 27 stages are required including loading and unloading the fabric, which is very inefficient, and additionally it requires a large installation area.

Furthermore, even when such methods are adopted, conventional water-based binders cannot avoid thickening of inks that may cause clogging during continuous printing (screen printing); accordingly, printing ( ) with care is required.

Under such circumstances, the inventors of the present invention previously proposed the following invention (Patent Literature 1) as a continuous printing method by a rotary multicolor screen printing machine: after printing a white hiding layer, a tack prevention layer is printed in order to prevent after-tack of the ink generated through heating by a hot air dryer, then as a color ink for multicolor printing, a water-based ink comprising an oil component that is emulsified by a surfactant having a clouding point.

However, since this method requires an addition of a tack prevention layer in the normal printing process, an extra step is added, and a volatile organic solvent that is contained as an oil component causes environmental problems.

Thus, development of an easy continuous printing method by a rotary multicolor screen printing machine using a water-based printing binder, without causing environmental problems, has been awaited.

### CITATION LIST

### Patent Literature

Patent Literature 1: JP A 2007-332523

### SUMMARY OF INVENTION

### Problem to be Solved by the Invention

An object of the present invention is to provide a method for easily carrying out continuous printing by a rotary multicolor screen printing machine using a water-based printing binder, without causing environmental problems, etc.

### Means of Solving the Problem

The present inventors have devoted themselves to solve the above problem, and found that, in a multicolor printing method by a rotary multicolor screen printing machine, when a specific water-based printing ink is used and continuous printing is carried out while the temperature of the tables (pallets) of said machine is maintained at a specific temperature, continuous printing by said printing machine can be easily achieved without causing environmental problems even when a water-based printing binder is used; thus, after further study, the inventors have accomplished the present invention.

The present invention is comprised of the following.
1. A heating-type multicolor printing method using a rotary multicolor screen printing machine, characterized in that (1) a water-based printing binder comprising a thickening inhibiting component is used, and (2) continuous printing is performed while maintaining the temperature of the table (pallet) of the printing machine at 60-100° C.
2. The heating-type multicolor printing method according to the above 1, wherein the thickening inhibiting component is a hydrophilic solvent having a boiling point higher than that of water.
3. The heating-type multicolor printing method according to the above 1 or 2, wherein the thickening inhibiting component is a polyalcohol.
4. The heating-type multicolor printing method according to any one of the above 1 to 3, wherein the water-based printing binder comprises, as a thickening inhibiting component, 10-60% of a hydrophilic solvent having a boiling point higher than that of water.
5. The heating-type multicolor printing method according to any one of the above 1 to 4, wherein the water-based printing binder comprises, as a thickening inhibiting component, 2-10% of urea.
6. The heating-type multicolor printing method according to any one of the above 1 to 4, wherein the water-based printing binder does not comprise an oil component.
7. The heating-type multicolor printing method according to any one of the above 1 to 6, wherein the water-based printing binder is for a white hiding layer and/or a colored layer.
8. The heating-type multicolor printing method according the above 7, wherein the print-application quantity of the white hiding layer is 70-110 g/m² and/or the print-application quantity of the colored layer is 15-50 g/m².
9. A printed fabric printed by the heating-type multicolor printing method according to any one of the above 1 to 8.

The present invention is based on the following findings.

### (1) Problems in Water-Based Printing Binder

Continuous printing by a rotary multicolor screen printing machine is usually carried out as follows: at first a fabric is loaded on a table (pallet) of the machine while the machine is inactivated, then after aligning the screen stencil, the machine is activated and continuous printing is started, with simultaneous activation of a hot air dryer.

In the above printing operations, when a plastisol ink comprising vinyl chloride is used, the ink becomes semi-gelled by only a 6-10 s exposure to the hot air dryer after printing, without generation of after-tack on the ink surface; accordingly, continuous printing is possible.

However, when a water-based printing binder is used instead of the plastisol ink comprising vinyl chloride, the following problems occur and continuous printing by a rotary multicolor screen printing machine is impossible.

### (Problem 1)

As described above, when a plastisol ink comprising vinyl chloride is used, the ink becomes semi-gelled by only a 6-10 s exposure to a hot air dryer immediately after printing without generation of after-tack on the ink surface; accordingly, continuous printing is possible.

However, in the case of water-based printing binders, they are not completely dried by only a 6-10 s exposure to a hot air dryer immediately after printing.

As a result, after-tack generates on the ink surface, and continuous printing is impossible.

### (Problem 2)

When a rotary multicolor screen printing machine is used, since printed surfaces cannot be cooled as in the case of elliptical multi-station screen printing machines, the temperature of the printed surface that has been irradiation-dried by a hot air dryer becomes as high as 80-100° C. immediately after drying, and the surface temperature becomes 50-60° C. when it is transferred to the next screen stencil.

Therefore, during continuous printing by rotary multicolor screen printing machine, the temperature of the tables (pallets) and screen stencils inevitably increases, resulting in evaporation of water content in the water-based printing binder.

Consequently, the ink thickens and clogging occurs on the screen stencil, so that continuous printing is impossible.

### (Problem 3)

Generally, rotary multicolor screen printing machines have a small number of stages compared to elliptical multicolor screen printing machines, and equipment of hot air dryers and cooling places with a number identical to the number of colors is impossible; therefore, multicolor printing is impossible.

Accordingly, printing with water-based printing binders is carried out by hand screen printing using a long screen platform and a T-shirt printing table, or using an elliptical multi-station screen printing machine wherein stages with 30 stations or more are equipped.

However, with hand screen printing, printing objects are completely dried by a dryer or fan after printing each color, then printing the next color is carried out; accordingly, while blocking or ink-build-up on a screen bottom does not occur during printing, all operations are performed manually and printed objects with a specific level of quality cannot be obtained; this is extremely inefficient.

Furthermore, with an elliptical multi-station screen printing machine, printing is carried out as follows: after printing the first ink, 2 stages of exposure to a hot air dryer is performed, then 2 stages of cooling is carried out to prevent blocking on the back of the next screen stencil, then printing the next ink is performed.

However, such a printing method is possible with a large number of stages. For example, 6-color printing requires 32 stages including loading and unloading the fabric, which is very inefficient and requires a large installation area.

### (Problem 4)

As a continuous printing method by a rotary multicolor screen printing machine using a water-based printing binder, as mentioned above, there is a method using a tack-prevention aqueous printing composition proposed by the present applicant. However, the method requires addition of a tack prevention layer in addition to general printing processes, so that one extra step is necessary, and moreover, because the composition comprises a volatile organic solvent as an oil component, it may cause environmental problems.

### (2) Solution

It has been found that the above problems can be solved by the following means.

### (Re: Problem 1)

To maintain the temperature of the tables (pallets) of the rotary multicolor screen printing machine at 60-100° C.

Namely, before starting the continuous printing, each table (pallet) is preheated to 60-100° C., then printing is started, and continuous printing is carried out while maintaining this temperature; then evaporation of water occurs during printing, leading to semi-dried condition of the ink, so that the ink surface is completely dried by only a short time (6-10 s) of exposure to a hot air dryer after printing.

As a result, generation of after-tack can be prevented.

### (Re: Problem 2)

As a water-based printing binder, those wherein separation of the ink does not occur even when it is heated and its water content evaporates, and wherein the degree of an increase in the viscosity is limited within a certain range, namely, those having a thickening inhibiting component, are used. As the thickening inhibiting component, a hydrophilic solvent having a boiling point higher than that of water, as well as urea, etc. are effective.

Namely, by blending a thickening inhibiting component into the water-based printing binder, thickening of the ink can be inhibited even in the above-described 60-100° C. heating-type continuous printing method.

As a result, clogging of the screen stencils due to thickening of inks can be prevented.

The present invention relates to a heating-type continuous printing method by a rotary multicolor screen printing machine without using tack prevention layers; accordingly, the problems 3 and 4 do not occur.

As described above, the following requirements must be satisfied to enable heating-type continuous printing by a rotary multicolor screen printing machine using a water-based printing binder.

### (Requirement 1)

As a water-based printing binder, those having a thickening inhibiting component is used.

### (Requirement 2)

The temperature of the tables (pallets) of the printing machine is maintained at 60-100° C.

It is speculated that, in the present invention, heating-type continuous printing by a rotary multicolor screen printing machine becomes possible even when a water-based printing binder is used, because of the following reasons.

It is considered that because those having a specific thickening inhibiting component are used as the water-based printing binder, separation of the ink does not occur even when it is heated and its water content evaporates, and the degree of increase in the viscosity is limited to a certain range.

As mentioned above, in the present invention, by adopting the above specific water-based printing binder (Requirement 1) and the specific temperature-control method (Requirement 2), heating-type continuous printing by a rotary multicolor screen printing machine is achieved for the first time, and in addition, the invention is very valuable in terms of simple method and environmental friendliness.

Hereinafter, the present invention is described in detail.

The heating-type continuous printing method of the present invention is characterized by using a water-based printing binder comprising a thickening inhibiting component and by maintaining the temperature of the tables (pallets) of the printing machine in the rage of 60-100° C. in a multicolor printing method using the rotary multicolor screen printing machine.

The constitutive requirements of the present invention: (A) rotary multicolor screen printing machine, (B) water-based printing binder, (C) printing method, and (D) products, etc. are explained below.

### (A) Rotary Multicolor Screen Printing Machine

In a rotary multicolor screen printing machine, stages consisting of a screen stencil (wherein a screen mesh is extended on a main body) and a hot air dryer are arranged radially on the circumference of the turn table, and multicolor screen printing is enabled by rotating and revolving tables (pallets=printing tables) around the turn table in an intermittent manner; this is a rotary (turn-table type) automatic printing machine.

A rotary multicolor screen printing machine consists of, among the total 8-20 stages, one empty stage for each of loading and removal a fabric to be printed (without hot air dryer or screen stencil), 1-5 stages with a hot air dryer, and remaining stages with a screen stencil.

The upper surface of the table (pallet=printing table) has tackiness, so that the fabric to be printed is not detached during printing processes. Loading and removal of the fabric to be printed are usually carried out manually in accordance with the action of the rotary multicolor screen printing machine.

Examples of the rotary multicolor screen printing machine include Synchro Print by MHM, Challenger by M&R, and Hawk Compact by TAS International, but are not limited thereto. Any machines that can carry out the similar printing processes may be used.

As printing devices other than those mentioned above, elliptical multi-station screen printing machines wherein a part of the cooling devices and dryers is stopped or removed can be considered as a printing machine similar to the rotary multicolor screen printing machines.

### (B) Water-Based Printing Binder

In heating-type continuous printing of a water-based printing binder by a rotary multicolor screen printing machine of the present invention, during continuous printing, printing is carried out while each table (pallet) is heated, i.e. in the heat condition at 60-100° C.; accordingly, the ink on the screen stencil during continuous printing is heated to 40-60° C.

Therefore, to realize the above heating-type continuous printing, inks that show no clogging and only a limited degree of an increase in viscosity even under being heated at the above temperature range must be adopted.

To achieve this, as the water-based printing binder, those blended with a thickening inhibiting component, such as a hydrophilic solvent having a boiling point higher than that of water, as well as urea, etc., are effective.

Thus, by blending a thickening inhibiting component into the water-based printing binder, thickening of the ink can be inhibited even in the above-described 60-100° C. heating-type continuous printing method.

As a result, clogging of the screen stencils due to thickening of inks can be prevented.

As the water-based printing binder, those blended with 10-60% of a hydrophilic solvent having a boiling point higher than that of water are effective. When the blend amount is less than 10%, drying is not delayed sufficiently, resulting in enhanced clogging and thickening of the inks to adversely affect continuous printing, which is undesirable. In addition, when the blend amount is more than 60%, drying during continuous printing is insufficient, causing blocking and ink-build-up on a screen bottom, which is also undesirable.

Furthermore, when 2-10% of urea is blended in the above hydrophilic solvent having a boiling point higher than that of water, further prevention of clogging and prevention of an increase in viscosity of the ink can be achieved.

When the blend amount of urea is 2% or less, synergetic effect with the hydrophilic solvent is not exhibited; when it is more than 10%, the drying-delay effect is too high so that blocking and ink-build-up on a screen bottom occur during continuous printing, which is undesirable.

The above-mentioned blending of a hydrophilic solvent having a boiling point higher than that of water and urea, etc. into the water-based printing binder enables to prevent clogging and an increase in the viscosity of the ink, so that printing is not inhibited even when the temperature of the ink on the screen stencil increases to 40-60° C.; therefore, continuous printing becomes possible.

As a method to add the above hydrophilic solvent into the water-based printing binder, in general, the solvent is added to the composition consisting of an emulsion resin that is polymerized in water as a fixing agent and a coloring agent, etc.; when a hydrophilic solvent with an amount of exceeding a certain level is added, the addition may become difficult due to the blending capacity.

In such a case, a resin (as a fixing agent) polymerized in the hydrophilic solvent may be used to blend a larger amount of hydrophilic solvent into the water-based printing binder.

Examples of the hydrophilic solvent having a boiling point higher than that of water include propylene glycol, ethylene glycol, diethylene glycol, dipropylene glycol, glycerin, etc.; however, examples are not limited thereto and any hydrophilic solvent having a boiling point higher than that of water can be adopted.

Next, water-based printing binders used for white hiding layers or colored layers are explained.

As the emulsion resin polymerized in water or polymerized in a hydrophilic solvent, which is used for a white hiding layer or a colored layer, examples are not particularly limited, but those having a certain level of quality as clothing, i.e., those having washing fastness, rubbing fastness and soft texture may be used.

Examples of the above emulsion resins include, (meth) acrylic acid ester resin emulsion, urethane resin emulsion, ethylene/vinyl acetate resin emulsion, nylon resin emulsion, polyester resin emulsion, styrene butadiene latex emulsion, acrylonitrile resin emulsion, acrylonitrile styrene latex emulsion, etc. However, examples are not limited thereto, and a plurality of these emulsion resins may be blended for use.

In addition, as a white pigment for formation of white hiding layers, substances such as titanium oxide, aluminum silicate, silicon oxide, calcium carbonate, talc, zinc oxide, sedimentary barium sulfate, kaolin clay, aluminum hydroxide, alumina, etc. may be used, but examples of white pigment are not limited thereto, and combination of two or more kinds of these may also be used.

Pigments for formation of colored layers are not particularly limited, and any organic and inorganic pigments may be used as coloring agents.

Examples include black pigments such as carbon black and iron oxide black pigment, etc.; red pigments such as quinacridone pigment, chromphthal pigment, azo pigment, diketopyrrolopyrrole pigment, anthraquinone pigment, etc.; yellow pigments such as azo pigment, imidazolone pigment, titanium yellow pigment, etc.; orange pigments such as indanthrene pigment, azo pigment etc.; blue pigments such as phthalocyanine pigment, ultramarine, iron blue, etc.; green pigments such as phthalocyanine pigment, etc.; violet pigments such as dioxazine pigment, quinacridone pigment, pearl pigment, luminous pigment, glitter, aluminum pigment, etc.; these pigments may be mixed in any blending ratio to achieve the desired color and used for printing.

Furthermore, the above white hiding pigment and coloring pigment may be blended into an ink that forms a colored layer to achieve the ink having a hiding power.

Other than those mentioned above, curing agent, dispersant, deforming agent, emulsifier, pH adjuster, UV absorbing agent, thickener, discharging agent, antioxidant, antiseptic agent, plasticizer, leveling agent, softener, tack prevention agent, and fluorescent whitening agent may further be added into the water-based rubber binder or the ink that form a white hiding layer or a colored layer; however, examples are not limited thereto, and other additives may be blended if necessary.

### (C) Printing Method

### 1) Warming of Tables (Pallets)

In the heating-type continuous printing of the present invention, in order to print the above water-based printing binder efficiently with a specific level of quality using a rotary multicolor screen printing machine, it is necessary to heat each table (pallet) before start of the continuous printing and during the continuous printing; the following method is preferably adopted.

Each table (pallet) of the rotary multicolor screen printing machine is heated to 60-100° C. before starting to print, then printing is carried out using a screen stencil of the first color by rotating each table (pallet).

Then, continuous printing may be carried out using screen stencils of the second and later colors; however, when the temperature of each table (pallet) for the second and later colors cannot be maintained at 60-100° C. due to the reasons such as heat absorption by water, a dryer may be equipped if necessary in the stage between the first and second colors, and/or similarly between the second and third colors and so on for the third and later colors, so that upon reaching the next stage, the printed ink is dried without after-tack, and continuous multicolor printing can be performed efficiently with a specific level of quality without blocking or ink-build-up on a screen bottom upon squeezing of the next screen stencil.

To realize this, during continuous printing, the heating temperature of each table (pallet) must be maintained in the range of 60-100° C.; with this, blocking and ink-build-up on a screen bottom do not occur and continuous multicolor printing of water-based rubber binders is possible with a high level of quality and efficiency.

When the heating temperature of each table (pallet) is 60° C. or less, drying of the printed water-based printing binder is insufficient, resulting in tackiness of the printed surface, and this will induce blocking and ink-build-up on a screen bottom when the printed surface is pressed by the next screen; thus, printed objects with a specific level of quality cannot be obtained.

Heating temperature of each table (pallet) of 100° C. or higher is not preferable because printed objects may burn, or the water-based printing binder on the screen stencil during continuous printing is heated to 80° C. or higher and volatile components including water evaporate, resulting in an extreme increase in the viscosity of said binder.

Furthermore, when any other printing methods are adopted such as a method wherein a white hiding layer is printed as the first color, then the second and later colors are multicolor-printed on the white hiding layer, or a method wherein a color ink is printed as the first color, then the second and later colors are multicolor printed, efficient and high-quality printing is possible without blocking of the water-based printing binder used in the rotary multicolor printing machine and without ink-build-up on a screen bottom, by adopting the above-described printing method.

As a heat source of each table (pallet) before start of printing and during continuous printing, a dryer attached to said printing machine, namely, far-infrared dryer, halogen heater, hot air dryer, etc. may be used.

In addition, each table (pallet) may be heated by means of a nichrome-wire heating device, a water- or oil-circulation type heating device that is built in each table (pallet), or by a heat source of a combination thereof.

Then, printed objects printed by a rotary multicolor screen printing machine are preferably subjected to heat treatment at 120-180° C. for 1-5 min by a tunnel dryer and others after printing, in order to increase their fastness.

### 2) Quantity of Application

In order to efficiently print a water-based printing binder with a specific level of quality using a rotary multicolor printing machine without blocking and ink-build-up on a screen bottom, the ink printed by said printing machine must be dried with good thermal efficiency.

To achieve this, the temperature of each table (pallet) must be maintained at 60-100° C. before start of printing and during printing as described above, and in addition, the ink to be printed should be held on the surface of the fabric to be printed, and no excessive quantity of the ink must be printed.

Namely, because the degree of tinting of the printed ink is determined by the concentration of the ink film formed on the surface of the fabric to be printed, the ink printed with an excessive application quantity only impregnates into the fibers, which is different from printing on papers and films. Accordingly, excessive application quantity of the ink deteriorates the texture of the printed fabric, and it also does not improve the degrees of tinting and hiding; moreover, the excessively printed ink decreases drying efficiency.

Therefore, by means of printing the ink only on the surface of the fabric to be printed, drying efficiency can be increased, and when inks can be efficiently dried, continuous printing of water-based printing binders by a rotary multicolor screen printing machine becomes possible.

In order to print only on the surface of the fabric to be printed, and to achieve soft texture with effective degrees of hiding and tinting, the application quantity may be set as follows.

Print-application quantity of white hiding layer is set to be 70-110 g/m², and print-application quantity of colored layer is set to be 15-50 g/m².

The application quantity of white hiding layer of 70 g/m² or less, and that of colored layer of 15 g/m² or less are not preferable, because degrees of hiding and tinting are insufficient or faint/patchy patterns are generated in the printed objects. In addition, when the application quantity of white hiding layer is 110 g/m² or more, and that of colored layer is 50 g/m² or more, it is not preferable because drying is insufficient and blocking and ink-build-up on a screen bottom occur during continuous printing.

Printing with the above application quantity can be easily performed using a screen mesh of 120-350 meshes/inch; however, the application quantity of an ink is not determined by the screen mesh alone, it differs depending on the hardness of a table (pallet) and the hardness of squeezees used for screen printing.

In addition, sharpness and accuracy of the design to be printed can be finer with a finer screen mesh.

Accordingly, a screen mesh of 120-350 meshes/inch in combination with selection of hardness of each table (pallet) and squeezee for maintaining the above application quantity enables continuous printing by a rotary multicolor screen printing machine.

### (D) Products

Products of the invention can be produced by printing a water-based printing binder onto textile products such as clothing, knitted goods, and textile fabrics by the above printing method, etc., using a white hiding ink and/or color inks, in a continuous printing method by a rotary multicolor screen printing machine.

Examples of fabric include synthetic fibers such as nylon, polyester, acrylonitrile, etc.; semi synthetic fibers such as acetate, rayon, etc.; natural fibers such as cotton, silk, wool, linen, etc.; and mixed fibers and nonwoven fabrics thereof.

Examples of clothing include T shirts, sweat shirts, jersey knits, pants, sweat suits, and sports clothing, etc.

### ADVANTAGEOUS EFFECTS OF INVENTION

(1) In a rotary multicolor screen printing machine of the present invention, the temperature of each table (pallet) is maintained at 60-100° C. during printing; however, since a thickening inhibiting component is blended in the water-based printing binder, an increase in viscosity is limited to a certain range even when water evaporates, and therefore, the printed water-based printing binder does not generate blocking or ink-build-up on a screen bottom during continuous printing, enabling multicolor printing.

Here, since the water-based printing binder does not comprise a volatile organic solvent, no VOC problem and environmental problem occur, which is advantageous.

(2) The present invention relates to a heating-type continuous printing method by a rotary multicolor screen printing machine using a water-based printing binder; compared to conventional hand screen method and elliptical multicolor printing machines, the inventive method enables highly efficient printing with a specific level of quality, and the method also does not require a wide installation area as in the case of elliptical multicolor printing machines; therefore, the method provides printing objects with excellent quality at extremely high productivity and efficiency.
(3) Printing substances of the present invention do not comprise a plasticizer such as vinyl chloride and phthalic acid ester, etc.; therefore, products with a specific level of quality without environmental problems, having good breathability, light weight, and washing fastness can be efficiently produced.
(4) Compared to the continuous printing method by a rotary multicolor screen printing machine proposed previously by the applicant of the invention, the method of the present invention does not require a tack prevention layer, leading to an increase in productivity.

### EMBODIMENTS FOR CARRYING OUT THE INVENTION

Hereinafter, the present invention is described in detail with reference to examples; however, the invention is not limited to these examples.

In the examples below, “parts” and “%” mean “parts by weight” and “% by weight,” respectively, unless otherwise specified.

### Example 1

### Formation of Water-Based Printing Binder

### 1. Water-Based Printing Binder for White Hiding Layer

50 parts of 60% acrylic resin emulsion (Nikasol FX-138Y: Nippon Carbide Industries, Co., Inc.), 20 parts of propylene glycol, 3 parts of urea, 20 parts of titanium oxide (Titanium R-630: Ishihara Sangyo Kaisha, Ltd.), 0.5 part of a defoaming agent (Deforming agent H: Matsui Shikiso Chemical Co., Ltd.), 1 part of 20% sodium hexametaphosphate aqueous solution, 0.5 part of ammonia water, 3 parts of a thickening agent (Printgen NFV: Matsui Shikiso Chemical Co., Ltd.), and 2 parts of a curing agent (Fixer F: Matsui Shikiso Chemical Co., Ltd.) were homogeneously mixed to give a water-based printing binder for white hiding layer.

### 2. Water-Based Printing Binder for Colored Layer

50 parts of 30% acrylic resin emulsion (Matsuminsol MR-50: Matsui Shikiso Chemical Co., Ltd.), 18 parts of ethylene glycol, 4 parts of urea, 0.5 part of a defoaming agent (Deforming agent H: Matsui Shikiso Chemical Co., Ltd.), 0.5 part of ammonia water, 1 part of a thickening agent (Printgen NFV: Matsui Shikiso Chemical Co., Ltd.), 2 parts of a thickening agent (Emacol R-620: Matsui Shikiso Chemical Co., Ltd.), 2 parts of a curing agent (Fixer F: Matsui Shikiso Chemical Co., Ltd.), and 22 parts of water were homogeneously mixed to give a water-based printing binder for colored layer.

### Formation of Ink

### 1. Red Ink

10 parts of a red dispersion pigment (Matsumin Neo Color Red MFB: Matsui Shikiso Chemical Co., Ltd.) was blended with 100 parts of the water-based printing binder for colored layer of the above 2, to give a red ink.

### 2. Yellow Ink

In the red ink of the above 1, 10 parts of a yellow dispersion pigment (Matsumin Neo Color Yellow MFR) was blended instead of 10 parts of the red dispersion pigment, to give a yellow ink.

### 3. Blue Ink

In the red ink of the above 1, 10 parts of a blue dispersion pigment (Matsumin Neo Color Blue MB) was blended instead of 10 parts of the red dispersion pigment, to give a blue ink.

### 4. Black Ink

In the red ink of the above 1, 10 parts of a black dispersion pigment (Matsumin Neo Color Black MK) was blended instead of 10 parts of the red dispersion pigment, to give a black ink.

### Printing Method

Using the water-based printing binder for white hiding layer and the above inks 1-4, continuous multicolor screen printing was performed by repeating the following processes involving 1^{st} to 16^{th} stations of the rotary multicolor screen printing machine (16 stages: M&R Companies).

Before starting to print, an object to be printed is mounted on each table (pallet) and each screen stencil is aligned, then while rotating the machine, only hot air dryers are operated to increase the temperature of each table (pallet) to 80° C.

1^{st} station: Mounting a dark-blue fabric to be printed.
2^{nd} station: The water-based printing binder for white hiding layer is printed using a screen stencil of 225 meshes/inch, with an application quantity of 98 g/m² for patterns A, B, C and D.
3^{rd} station: The white hiding layer is dried by the hot air dryer set at 370° C.
4^{th} station: The water-based printing binder for white hiding layer is printed using a screen stencil of 225 meshes/inch, with an application quantity of 82 g/m² for the superimposed patterns A, B, C and D.
5^{th} station: The white hiding layer is dried by the hot air dryer set at 400° C.
6^{th} station: The red ink is printed as a colored layer onto the white hiding layer of pattern A using a screen stencil of 300 meshes/inch, with an application quantity of 21 g/m².
7^{th} station: The yellow ink is printed as a colored layer onto the white hiding layer of pattern B using a screen stencil of 300 meshes/inch, with an application quantity of 21 g/m².
8^{th} station: The blue ink is printed as a colored layer onto the white hiding layer of pattern C using a screen stencil of 300 meshes/inch, with an application quantity of 21 g/m².
9^{th} station: The black ink is printed as a colored layer onto the white hiding layer of pattern D using a screen stencil of 300 meshes/inch, with an application quantity of 21 g/m².
10^{th} to 13^{th} stations: Empty stage.
14^{th} station: The colored layers are dried by the hot air dryer set at 480° C.
15^{th} station: Empty stage.
16^{th} station: The printed object is unloaded. The object printed by the rotary multicolor printing machine is put in a tunnel dryer at 160° C. for 2 min, for heat treatment.

### Temperature of the Table

### Pallet

The temperature of each table (pallet) during printing 2000 objects was 70-85° C.

### Screen Stencil

During continuous printing, no clogging and no extreme thickening of the inks occurred in each screen stencil, and no blocking or ink build-up occurred on the back of the screen stencil during multicolor printing, and no unevenness or faint/patchy patterns were generated on the printed surfaces.

### Product

In the printed objects obtained, the red pattern of A, yellow pattern of B, blue pattern of C and black pattern of D were printed on a dark-blue fabric, and they were light weight, had superior hiding power and stretch properties, and showed excellent fastness in 30 times of repeated test for washing fastness in accordance with JIS L-0217 103.

In addition, there was no difference in the quality between the first and the 2000th objects printed.

### Example 2

### Printing Method

Before starting to print, an object to be printed is mounted on each table (pallet) and each screen stencil is aligned, then while rotating the machine, only hot air dryers are operated to increase the temperature of each table (pallet) to 75° C.

1^{st} station: Mounting a white fabric to be printed.
2^{nd} station: The red ink is printed as a colored layer on magenta parts of a photoengraved (color-decomposed) dog pattern using a screen stencil of 225 meshes/inch, with an application quantity of 38 g/m².
3^{rd} station: The red ink is dried by the hot air dryer set at 370° C.
4^{th} station: The yellow ink is printed as a colored layer on yellow parts of the photoengraved (color-decomposed) dog pattern using a screen stencil of 225 meshes/inch, with an application quantity of 37 g/m².
5^{th} station: Empty stage.
6^{th} station: The blue ink is printed as a colored layer on cyan parts of the photoengraved (color-decomposed) dog pattern using a screen stencil of 225 meshes/inch, with an application quantity of 38 g/m².
7^{th} station: The yellow and blue inks are dried by the hot air dryer set at 310° C.
8^{th} station: Empty stage.
9^{th} station: The black ink is printed as a colored layer on black parts of the photoengraved (color-decomposed) dog pattern using a screen stencil of 225 meshes/inch, with an application quantity of 38 g/m².
10^{th} to 13^{th} stations: Empty stage.
14^{th} station: The color ink layers are dried by the hot air dryer set at 430° C.
15^{th} station: Empty stage.
16^{th} station: The printed object is unloaded.

The object printed by the rotary multicolor printing machine is put in a tunnel dryer at 160° C. for 2 min, for heat treatment.

### Temperature of the Table

### Pallet

The temperature of each table (pallet) during printing 2000 objects was 60-80° C.

### Screen Stencil

During continuous printing, no clogging and no extreme thickening of the inks occurred in each screen stencil, and no blocking or ink build-up occurred on the back of the screen stencil during multicolor printing, and no unevenness or faint/patchy patterns were generated on the printed surfaces.

### Product

In the printed objects obtained, a photographic dog pattern was printed on a white fabric, and they had high breathability and light weight, and showed excellent fastness in 30 times of repeated test for washing fastness in accordance with JIS L-0217 103.

In addition, there was no difference in the quality between the first and the 2000th objects printed.

### Example 3

### Printing Method

Before starting to print, an object to be printed is mounted on each table (pallet) and each screen stencil is aligned, then while rotating the machine, only hot air dryers are operated to increase the temperature of each table (pallet) to 80° C.

1^{st} station: Mounting a red fabric to be printed that has been dyed with a dischargeable dye.
2^{nd} station: A discharge ink made by blending 100 parts of a discharge binder (Matsumin Binder 301DS: Matsui Shikiso Chemical Co., Ltd.) and 8 parts of a discharging agent (Decroline Soluble Conc.: BASF) is printed using a screen stencil of 135 meshes/inch that covers the entire photographic dog pattern of Example 2 with an application quantity of 60 g/m².
3^{rd} station: The discharge ink is dried by the hot air dryer set at 370° C.
4^{th} station: The red ink of Example 1 is printed as a colored layer on magenta parts of the photoengraved (color-decomposed) dog pattern using a screen stencil of 225 meshes/inch, with an application quantity of 35 g/m².
5^{th} station: The yellow ink of Example 1 is printed as a colored layer on yellow parts of the photoengraved (color-decomposed) dog pattern using a screen stencil of 225 meshes/inch, with an application quantity of 35 g/m².
6^{th} station: Empty stage.
7^{th} station: The red and yellow inks are dried by the hot air dryer set at 370° C.
8^{th} station: The blue ink of Example 1 is printed as a colored layer on cyan parts of the photoengraved (color-decomposed) dog pattern using a screen stencil of 225 meshes/inch, with an application quantity of 35 g/m².
9^{th} station: The black ink is printed as a colored layer on black parts of the photoengraved (color-decomposed) dog pattern using a screen stencil of 225 meshes/inch, with an application quantity of 35 g/m².
10^{th} station: The blue and black inks are dried by the hot air dryer set at 430° C.
11^{th} station: Empty stage.
12^{th} station: 100 parts of a silver ink (Metallic Binder 301: Matsui Shikiso Chemical Co., Ltd.) is printed as a colored layer for the letters “MATSUI” using a screen stencil of 80 meshes/inch with an application quantity of 40 g/m², below the photographic dog pattern.
13^{th} station: Empty stage.
14^{th} station: The silver ink layer is dried by the hot air dryer set at 480° C.
15^{th} station: Empty stage.
16^{th} station: The printed object is unloaded.

The object printed by the rotary multicolor printing machine is put in a tunnel dryer at 160° C. for 2 min, for heat treatment.

### Temperature of the Table

### Pallet

The temperature of each table (pallet) during printing 500 objects was 70-90° C.

### Screen Stencil

During continuous printing, no clogging and no extreme thickening of the inks occurred in each screen stencil, and no blocking or ink build-up occurred on the back of the screen stencil during multicolor printing, and no unevenness or faint/patchy patterns were generated on the printed surfaces.

### Product

In the printed objects obtained, a photographic dog pattern was clearly printed on the discharged white area of a red fabric, and also silver letters “MATSUI” were printed on the red fabric. In terms of quality, they had high breathability, soft texture and light weight, and showed excellent fastness in 30 times of repeated test for washing fastness in accordance with JIS L-0217 103.

In addition, there was no difference in the quality between the first and the 500th objects printed.

### Example 4

### Formation of Ink

### 1. Red Ink

10 parts of a red dispersion pigment (Matsumin Neo Color Red MFB: Matsui Shikiso Chemical Co., Ltd.) was blended with 100 parts of the white ink used for the white hiding layer of Example 1, to give a red ink.

### 2. Yellow Ink

Instead of the above red dispersion pigment, 10 parts of a yellow dispersion pigment (Matsumin Neo Color Yellow MFR) was blended to give a yellow ink.

### 3. Blue Ink

Instead of the above red dispersion pigment, 10 parts of a blue dispersion pigment (Matsumin Neo Color Blue MB) was blended to give a blue ink.

### 4. Black Ink

Instead of the above red dispersion pigment, 10 parts of a black dispersion pigment (Matsumin Neo Color Black MK) was blended to give a black ink.

### Printing Method

Before starting to print, an object to be printed is mounted on each table (pallet) and each screen stencil is aligned, then while rotating the machine, only hot air dryers are operated to increase the temperature of each table (pallet) to 75° C.

1^{st} station: Mounting a blue fabric to be printed.
2^{nd} station: The red ink is printed as a colored/hiding layer for a pattern A using a screen stencil of 225 meshes/inch with an application quantity of 81 g/m².
3^{rd} station: The red ink is dried by the hot air dryer set at 370° C.
4^{th} station: The yellow ink is printed as a colored/hiding layer for a pattern B using a screen stencil of 225 meshes/inch with an application quantity of 81 g/m².
5^{th} station: Empty stage.
6^{th} station: The blue ink is printed as a colored/hiding layer for a pattern C using a screen stencil of 225 meshes/inch with an application quantity of 81 g/m².
7^{th} station: The yellow and blue inks are dried by the hot air dryer set at 310° C.
8^{th} station: Empty stage.
9^{th} station: The black ink is printed as a colored/hiding layer for a pattern D using a screen stencil of 225 meshes/inch with an application quantity of 81 g/m².
10^{th} to 13^{th} station: Empty stage.
14^{th} station: The color-ink/hiding layers are dried by the hot air dryer set at 430° C.
15^{th} station: Empty stage.
16^{th} station: The printed object is unloaded.

The object printed by the rotary multicolor printing machine is put in a tunnel dryer at 150° C. for 2 min, for heat treatment.

### Temperature of the Table

### Pallet

The temperature of each table (pallet) during printing 1000 objects was 60-80° C.

### Screen Stencil

During continuous printing, no clogging and no extreme thickening of the inks occurred in each screen stencil, and no blocking or ink build-up occurred on the back of the screen stencil during multicolor printing, and no unevenness or faint/patchy patterns were generated on the printed surfaces.

### Product

In the printed objects obtained, pastel patterns of A, B, C and D were printed on a blue fabric, and they had soft texture, stretch properties and light weight, and showed excellent fastness in 30 times of repeated test for washing fastness in accordance with JIS L-0217 103.

In addition, there was no difference in the quality between the first and the 1000th objects printed.

### Example 5

### Formation of Water-Based Printing Binder

### 1. Water-Based Printing Binder for White Hiding Layer

60 parts of 60% acrylic resin polymerized in propylene glycol (Matsuminsol MR-5000: Matsui Shikiso Chemical Co., Ltd.), 10 parts of propylene glycol, 3 parts of urea, 20 parts of titanium oxide (Titanium R-630: Ishihara Sangyo Kaisha, Ltd.), 0.5 part of a defoaming agent (Deforming agent H: Matsui Shikiso Chemical Co., Ltd.), 1 part of 20% sodium hexametaphosphate aqueous solution, 0.5 part of ammonia water, 3 parts of a thickening agent (Printgen NFV: Matsui Shikiso Chemical Co., Ltd.), and 2 parts of a curing agent (Fixer F: Matsui Shikiso Chemical Co., Ltd.) were homogeneously mixed to give a water-based printing binder for white hiding layer.

### 2. Water-Based Printing Binder for Colored Layer

70 parts of 30% acrylic resin polymerized in propylene glycol (Matsuminsol MR-6000: Matsui Shikiso Chemical Co., Ltd.), 10 parts of ethylene glycol, 0.5 part of a defoaming agent (Deforming agent H: Matsui Shikiso Chemical Co., Ltd.), 0.5 part of ammonia water, 2 parts of a thickening agent (Printgen NFV: Matsui Shikiso Chemical Co., Ltd.), 2 parts of a curing agent (Fixer F: Matsui Shikiso Chemical Co., Ltd.), and 14 parts of water were homogeneously mixed to give a water-based printing binder for colored layer.

### Formation of Ink

### 1. Red Ink

10 parts of a red dispersion pigment (Matsumin Neo Color Red MFB: Matsui Shikiso Chemical Co., Ltd.) was blended with 100 parts of the water-based printing binder for colored layer of the above 2, to give a red ink.

### 2. Yellow Ink

Instead of the above red dispersion pigment, 10 parts of a yellow dispersion pigment (Matsumin Neo Color Yellow MFR) was blended to give a yellow ink.

### 3. Blue Ink

Instead of the red dispersion pigment of the above 1, 10 parts of a blue dispersion pigment (Matsumin Neo Color Blue MB) was blended to give a blue ink.

### 4. Black Ink

Instead of the red dispersion pigment of the above 1, 10 parts of a black dispersion pigment (Matsumin Neo Color Black MK) was blended to give a black ink.

### Printing Method

Using the water-based printing binder for white hiding layer and the above inks 1-4, continuous multicolor screen printing was performed by repeating the following processes involving 1^{st} to 16^{th} stations of the rotary multicolor screen printing machine (16 stages: M&R Companies).

Before starting to print, an object to be printed is mounted on each table (pallet) and each screen stencil is aligned, then while rotating the machine, only hot air dryers are operated to increase the temperature of each table (pallet) to 80° C.

1^{st} station: Mounting a dark-blue fabric to be printed.
2^{nd} station: The water-based printing binder for white hiding layer is printed using a screen stencil of 225 meshes/inch, with an application quantity of 100 g/m² for patterns A, B, C and D.
3^{rd} station: The white hiding layer is dried by the hot air dryer set at 370° C.
4^{th} station: The water-based printing binder for white hiding layer is printed using a screen stencil of 225 meshes/inch, with an application quantity of 79 g/m² for the superimposed patterns A, B, C and D.
5^{th} station: The white hiding layer is dried by the hot air dryer set at 400° C.
6^{th} station: The red ink is printed as a colored layer onto the white hiding layer of pattern A using a screen stencil of 300 meshes/inch, with an application quantity of 20 g/m².
7^{th} station: The yellow ink is printed as a colored layer onto the white hiding layer of pattern B using a screen stencil of 300 meshes/inch, with an application quantity of 20 g/m².
8^{th} station: The blue ink is printed as a colored layer onto the white hiding layer of pattern C using a screen stencil of 300 meshes/inch, with an application quantity of 20 g/m².
9^{th} station: The black ink is printed as a colored layer onto the white hiding layer of pattern D using a screen stencil of 300 meshes/inch, with an application quantity of 20 g/m².
10^{th} to 13^{th} stations: Empty stage.
14^{th} station: The colored layers are dried by the hot air dryer set at 480° C.
15^{th} station: Empty stage.
16^{th} station: The printed object is unloaded. The object printed by the rotary multicolor printing machine is put in a tunnel dryer at 160° C. for 2 min, for heat treatment.

### Temperature of the Table

### Pallet

The temperature of each table (pallet) during printing 2000 objects was 70-85° C.

### Screen Stencil

Compared to Example 1, a larger amount of hydrophilic solvent with a high boiling point was blended in the inks. Therefore, during continuous printing, no clogging and no extreme thickening of the inks occurred in each screen stencil, and no blocking or ink build-up occurred on the back of the screen stencil during multicolor printing, and no unevenness or faint/patchy patterns were generated on the printed surfaces.

### Product

In the printed objects obtained, the red pattern of A, yellow pattern of B, blue pattern of C and black pattern of D were printed on a dark-blue fabric, and they were light weight, superior in hiding power and stretch properties; they also showed more excellent fastness in 50 times of repeated test for washing fastness in accordance with JIS L-0217 103 compared with Example 1, because a larger amount of resin is blended in the binder.

In addition, there was no difference in the quality between the first and the 2000th objects printed.

### Comparative Example 1

### Printing Method

Using a plastisol ink consisting of vinyl chloride and a plasticizer instead of the water-based printing binder used in Example 1, continuous multicolor screen printing was performed by repeating the following processes involving 1^{st} to 16^{th} stations of the rotary multicolor screen printing machine (16 stages: M&R Companies).

As the plastisol ink, the following inks were used: a white hiding-layer ink (MIXO-1000 Super White: Union Ink Company), a red ink (MIXO-3007 Red Y/S, Union Ink Company), a yellow ink (MIXO-2042 Yellow R/S: Union Ink Company), a blue ink (MIXO-5001 Blue G/S: Union Ink Company), and a black ink (MIXO-8000 Black: Union Ink Company).

1^{st} station: Mounting a dark-blue fabric to be printed.
2^{nd} station: The plastisol ink for white hiding layer is printed using a screen stencil of 100 meshes/inch, with an application quantity of 155 g/m² for patterns A, B, C and D.
3^{rd} station: The white hiding layer is dried by the hot air dryer set at 260° C.
4^{th} station: The plasctisol ink for white hiding layer is printed using a screen stencil of 100 meshes/inch, with an application quantity of 150 g/m² for the superimposed patterns A, B, C and D.
5^{th} station: The white hiding layer is dried by the hot air dryer set at 260° C.
6^{th} station: The red ink is printed as a colored layer onto the white hiding layer of pattern A using a screen stencil of 180 meshes/inch, with an application quantity of 110 g/m².
7^{th} station: The yellow ink is printed as a colored layer onto the white hiding layer of pattern B using a screen stencil of 180 meshes/inch, with an application quantity of 110 g/m².
8^{th} station: The blue ink is printed as a colored layer onto the white hiding layer of pattern C using a screen stencil of 180 meshes/inch, with an application quantity of 110 g/m².
9^{th} station: The black ink is printed as a colored layer onto the white hiding layer of pattern D using a screen stencil of 180 meshes/inch, with an application quantity of 110 g/m².
10^{th} to 13^{th} stations: Empty stage.
14^{th} station: The colored layers are dried by the hot air dryer set at 260° C.
15^{th} station: Empty stage.
16^{th} station: The printed object is unloaded. The object printed by the rotary multicolor printing machine is put in a tunnel dryer at 160° C. for 2 min, for heat treatment.

### Temperature of the Table

### Pallet

The temperature of each table (pallet) during printing 2000 objects was 30-40° C.

### Screen Stencil

During continuous printing, no clogging and no thickening of the inks occurred in each screen stencil, and no blocking or ink-build-up occurred in the screen stencil.

### Product

The printed objects were heavy and had hard texture; and cracks were generated in the printed pattern after 30 times of repeated test for washing fastness in accordance with JIS L-0217 103.

In addition, products printed with the plastisol inks had environmental problems because they contained vinyl chloride and a phthalic-acid-ester plasticizer.

### Comparative Example 2

### Printing Method

Using the same printing machine and inks as in Example 1, while rotating the machine, only hot air dryers are operated to increase the temperature of each table (pallet) to 40-60° C.

1^{st} station: Mounting a dark-blue fabric to be printed.
2^{nd} station: The water-based printing binder for white hiding layer is printed using a screen stencil of 225 meshes/inch, with an application quantity of 102 g/m² for patterns A, B, C and D.
3rd station: The white hiding layer is dried by the hot air dryer set at 260° C.
4^{th} station: The water-based printing binder for white hiding layer is printed using a screen stencil of 255 meshes/inch, with an application quantity of 84 g/m² for the superimposed patterns A, B, C and D.
5^{th} station: The white hiding layer is dried by the hot air dryer set at 260° C.
6^{th} station: The red ink is printed as a colored layer onto the white hiding layer of pattern A using a screen stencil of 300 meshes/inch, with an application quantity of 22 g/m².
7^{th} station: The yellow ink is printed as a colored layer onto the white hiding layer of pattern B using a screen stencil of 300 meshes/inch, with an application quantity of 21 g/m².
8^{th} station: The blue ink is printed as a colored layer onto the white hiding layer of pattern C using a screen stencil of 300 meshes/inch, with an application quantity of 21 g/m².
9^{th} station: The black ink is printed as a colored layer onto the white hiding layer of pattern D using a screen stencil of 300 meshes/inch, with an application quantity of 22 g/m².
10^{th} to 15^{th} stations: Empty stage.
16^{th} station: The printed object is unloaded. The printed object obtained is put in a tunnel dryer at 160° C. for 2 min, for heat treatment.

### Screen Stencil

There was no problem in printing the white hiding layers, but drying by the hot air dryer after printing was insufficient, and tackiness of the ink surface remained, resulting in blocking on the back of the next screen stencil for the red ink.

In addition, ink build-up occurred on the back of the yellow screen stencil, blue screen stencil and black screen stencil because the inks did not dry completely, so that the printed objects lacked unevenness and smoothness and satisfactory printed objects could not be obtained.

Reasons for the occurrence of the above blocking and ink-build-up on the screen bottom are considered as follows.

(1) Before starting to print as well as during printing, the temperature of each table (pallet) was insufficient in terms of calorie to completely dry the printed inks.
(2) Although the temperature of each table (pallet) was increased to 40-60° C. before starting to print, the temperature decreased to approximately 30° C. during alignment of the screen stencil and filling the inks.

### Comparative Example 3

### Formation of Water-Based Printing Binder

### 1. Water-Based Printing Binder for White Hiding Layer

45 parts of acrylic resin emulsion having a Tg point of −30° C. (Nikasol FX-138Y: Nippon Carbide Industries, Co., Inc.), 10 parts of propylene glycol, 4 parts of urea, 30 parts of titanium oxide (Titanium R-630: Ishihara Sangyo Kaisha, Ltd.), 1 part of 20% sodium hexametaphosphate aqueous solution, 1 part of a defoaming agent (Deforming agent H: Matsui Shikiso Chemical Co., Ltd.), 0.3 part of ammonia water, 2.5 parts of a thickening agent (Emacol R-620: Matsui Shikiso Chemical Co., Ltd.), 14.2 parts of water, and 2 parts of a curing agent (Fixer F: Matsui Shikiso Chemical Co., Ltd.) were homogeneously mixed to give a water-based printing binder for white hiding layer.

### Water-Based Printing Binder for Tack Prevention Layer

40 parts of saturated polyester resin emulsion having a Tg point of −26° C. (KZT-0507:Unitika Ltd.), 15 parts of ethylene glycol, 4 parts of urea, 1 part of 20% sodium hexametaphosphate aqueous solution, 1 part of a defoaming agent (Deforming agent H: Matsui Shikiso Chemical Co., Ltd.), 0.3 part of ammonia water, 2.5 parts of a thickening agent (Emacol R-620: Matsui Shikiso Chemical Co., Ltd.), 34.2 parts of water, and 2 parts of a curing agent (Fixer F: Matsui Shikiso Chemical Co., Ltd.) were homogeneously mixed to give a water-based printing binder for tack prevention layer.

### Formation of Ink

### 1. Red Ink

30 parts of acrylic resin emulsion having a Tg point of −20° C. (Matsuminsol MR-50: Matsui Shikiso Chemical Co., Ltd.), 10 parts of ethylene glycol, 3 parts of urea, 23 parts of terpene, 2 parts of silicone oil (Silicone SH200: Dow Corning Toray, Co. Ltd.), 3 parts of a non-ionic surfactant having a clouding point of 40° C. (Emalgen 108: Kao Corporation), 19 parts of water, 2 parts of a curing agent (Fixer F: Matsui Shikiso Chemical Co., Ltd.), and 10 parts of a red dispersion pigment (Matsumin Neo Color Red MFB: Matsui Shikiso Chemical Co., Ltd.) were homogeneously mixed to give a red ink for colored layer.

### 2. Yellow Ink

Instead of the red dispersion pigment of the above 1, 10 parts of a yellow dispersion pigment (Matsumin Neo Color Yellow MFR: Matsui Shikiso Chemical Co., Ltd.) was homogeneously blended to give a yellow ink for colored layer.

### 3. Blue Ink

Instead of the red dispersion pigment of the above 1, 10 parts of a blue dispersion pigment (Matsumin Neo Color Blue MB: Matsui Shikiso Chemical Co., Ltd.) was homogeneously blended to give a blue ink for colored layer.

### 4. Black Ink

Instead of the red dispersion pigment of the above 1, 10 parts of a black dispersion pigment (Matsumin Neo Color Black MK: Matsui Shikiso Chemical Co., Ltd.) was homogeneously blended to give a blue ink for colored layer.

### Printing Method

While rotating the machine, only hot air dryers are operated to increase the temperature of each table (pallet) to 50-60° C.

1^{st} station: Mounting a dark-blue fabric to be printed.
2^{nd} station: The water-based printing binder for white hiding layer is printed using a screen stencil of 80 meshes/inch, with an application quantity of 139 g/m² for patterns A, B, C and D.
3rd station: The white hiding layer is dried by the hot air dryer set at 260° C.
4^{th} station: The water-based printing binder for white hiding layer is printed using a screen stencil of 100 meshes/inch, with an application quantity of 104 g/m² for the superimposed patterns A, B, C and D.
5^{th} station: The white hiding layer is dried by the hot air dryer set at 260° C.
6^{th} station: The tack prevention ink is printed as a tack prevention layer using a screen stencil of 100 meshes/inch, with an application quantity of 46 g/m² for the superimposed patterns A, B, C and D.
7^{th} station: The tack prevention layer is dried by the hot air dryer set at 260° C.
8^{th} station: The red ink is printed as a colored layer onto the white hiding layer of pattern A using a screen stencil of 225 meshes/inch, with an application quantity of 32 g/m².
9^{th} station: The yellow ink is printed as a colored layer onto the white hiding layer of pattern B using a screen stencil of 225 meshes/inch, with an application quantity of 32 g/m².
10^{th} station: The blue ink is printed as a colored layer onto the white hiding layer of pattern C using a screen stencil of 225 meshes/inch, with an application quantity of 32 g/m².
11^{th} station: The black ink is printed as a colored layer onto the white hiding layer of pattern D using a screen stencil of 225 meshes/inch, with an application quantity of 32 g/m².
12^{th} to 15^{th} stations: Empty stage.
16^{th} station: The printed object is unloaded. The printed object obtained is put in a tunnel dryer at 160° C. for 2 min, for heat treatment.

### Temperature of the Table

### Pallet

The temperature was 40-60° C.

### Screen Stencil

During continuous printing, ink-build-up on the screen bottom and blocking did not occur, and satisfactory printed objects were obtained.

Reasons for this are as follows: when the temperature of each table (pallet) is as low as 40-60° C. and drying of the ink surface is not sufficient, a tack prevention layer is formed on the entire white hiding layer, and even when the tack prevention layer is not completely dried, its ink surface has no tackiness so that ink-build-up on the screen bottom and blocking do not occur when pressed by the screen stencil of the next color ink.

Moreover, regarding the subsequent yellow, blue and black inks, their emulsifying system breaks when the temperature of each table (pallet) reaches 40° C., and the oil component within the ink comes out on the surface of the object to be printed; therefore the ink does not adhere to the back of the screen stencil, i.e., no ink-build-up on the screen bottom occurs. Thus, continuous printing is possible without problems.

However, this method has the following problems.

1) An extra tack prevention layer must be printed, so that one extra screen stencil and an extra step are required, resulting in a productivity lower than that of the method according to the present invention.
2) The tack prevention layer has a hard texture, which deteriorates the texture of products.
3) Since the inks used in this method comprise a volatile oil component, they might affect the environment and workers' health during work.

### Comparative Example 4

A water-based printing binder for white hiding layer was obtained similarly to Example 1, except that 20 parts of the propylene glycol of the water-based printing binder for white hiding layer used in Example 1 was replaced by 8 parts of propylene glycol and 12 parts of water, and that 3 parts of urea was decreased to 0.5 part.

A water-based printing binder for color ink layer was obtained similarly to Example 1, except that 18 parts of the ethylene glycol of the color ink for colored layer used in Example 1 was replaced by 7 parts of propylene glycol and 11 parts of water, and that 4 parts of urea was decreased to 0.5 part.

### Printing Method

The above inks were subjected to continuous printing in accordance with the processes identical to Example 1.

### Screen Stencil

Although blocking and ink-build-up on the screen bottom did not occur, clogging occurred in the screen stencil after printing 100 objects, and faint or patchy patterns were generated.

In addition, after printing 300 objects, viscosity of each ink increased and printing became impossible.

### Comparative Example 5

### Printing Method

Using the same printing machine and inks as in Example 1, while rotating the machine, only hot air dryers are operated to increase the temperature of each table (pallet) to 80° C.

1^{st} station: Mounting a dark-blue fabric to be printed.
2^{nd} station: The water-based printing binder for white hiding layer is printed using a screen stencil of 80 meshes/inch, with an application quantity of 137 g/m² for patterns A, B, C and D.
3^{rd} station: The white hiding layer is dried by the hot air dryer set at 370° C.
4^{th} station: The water-based printing binder for white hiding layer is printed using a screen stencil of 100 meshes/inch, with an application quantity of 98 g/m² for the superimposed patterns A, B, C and D.
5^{th} station: The white hiding layer is dried by the hot air dryer set at 400° C.
6^{th} station: The red ink is printed as a colored layer onto the white hiding layer of pattern A using a screen stencil of 135 meshes/inch, with an application quantity of 62 g/m².
7^{th} station: The yellow ink is printed as a colored layer onto the white hiding layer of pattern B using a screen stencil of 135 meshes/inch, with an application quantity of 61 g/m².
8^{th} station: The blue ink is printed as a colored layer onto the white hiding layer of pattern C using a screen stencil of 135 meshes/inch, with an application quantity of 60 g/m².
9^{th} station: The black ink is printed as a colored layer onto the white hiding layer of pattern D using a screen stencil of 135 meshes/inch, with an application quantity of 61 g/m².
10^{th} to 13^{th} stations: Empty stage.
14^{th} station: The color inks are dried by the hot air dryer set at 480° C.
15^{th} station: Empty stage.
16^{th} station: The printed object is unloaded. The printed object obtained is put in a tunnel dryer at 160° C. for 2 min, for heat treatment.

As a result, there was no problem in printing the white hiding layers, but drying of the layers by the hot air dryer after printing was insufficient, and blocking and ink-build-up on the screen bottom occurred, and printed objects had low degrees of coloring and hiding with rough printed surfaces; thus satisfactory printed objects could not be obtained. Namely, the occurrence of blocking and ink-build-up on the screen bottom in these processes is considered to be due to the low efficiency in drying because of the large application quantities of white hiding layers and colored layers, that is, due to the lack of complete drying.

### Comparative Example 6

### Printing Method

Using the same printing machine and inks as in Example 1, while rotating the machine, only hot air dryers were operated to increase the temperature of each table (pallet) to 80° C. as in Example 1; and multicolor screen printing was performed with the same conditions as in Comparative example 1, except that higher temperatures were set for the hot air dryers: 370° C. for the 3^{rd} station, 400° C. for the 5^{th} station, 400° C. for the 14^{th} station.

### Screen Stencil

During continuous printing, viscosity of the plastisol inks on each screen stencil increased from approximately 500 printed objects, and clogging and faint/patchy patterns occurred and satisfactory printed objects could not be obtained.

The results of the above Examples and Comparative examples confirmed that selection of the following two requirements of the present invention has a special meaning: (1) using a water-based printing binder that comprises a thickening inhibiting component, and (2) maintaining the temperature of the tables (pallets) of a rotary multicolor screen printing machine at 60-100° C.

### INDUSTRIAL APPLICABILITY

The printing method of the present invention exhibits superior printing applicability, generates no environmental problems, and provides excellent productivity; therefore, the inventive method can be used for rotary multicolor screen printing machines and can provide products with excellent quality.

1. A heating-type multicolor printing method using a rotary multicolor screen printing machine, characterized in that (1) a water-based printing binder comprising a thickening inhibiting component is used, and (2) continuous printing is performed while maintaining the temperature of the table (pallet) of the printing machine at 60-100° C.

2. The heating-type multicolor printing method according to claim 1, wherein the thickening inhibiting component is a hydrophilic solvent having a boiling point higher than that of water.

3. The heating-type multicolor printing method according to claim 1, wherein the thickening inhibiting component is a polyalcohol.

4. The heating-type multicolor printing method according to claim 1, wherein the water-based printing binder comprises, as a thickening inhibiting component, 10-60% of a hydrophilic solvent having a boiling point higher than that of water.

5. The heating-type multicolor printing method according to claim 1, wherein the water-based printing binder comprises, as a thickening inhibiting component, 2-10% of urea.

6. The heating-type multicolor printing method according to claim 1, wherein the water-based printing binder does not comprise an oil component.

7. The heating-type multicolor printing method according to claim 1, wherein the water-based printing binder is for a white hiding layer and/or a colored layer.

8. The heating-type multicolor printing method according to claim 7, wherein the print-application quantity of the white hiding layer is 70-110 g/m² and/or the print-application quantity of the colored layer is 15-50 g/m².

9. A printed fabric printed by the heating-type multicolor printing method according to claim 1.
